(19) United States
(12) Patent Application Publication
(10) Pub. No.: US 2025/0340969 A1
(43) Pub. Date: Nov. 6, 2025

(54) SULPHIDATION OF A SOLID METAL FEED COMPRISING NI AND/OR CO

(71) Applicant: Umicore, Brussels (BE)

(72) Inventor: Pieter VERHEES, Olen (BE)

(21) Appl. No.: 18/871,866

(22) PCT Filed: Jun. 9, 2023
(86) PCT No.: PCT/EP2023/065439

§ 371 Date: Dec. 5, 2024

(30) Foreign Application Priority Data
Jun. 10, 2022 (EP) 22178454.9

(51) Int. Cl. C22B 3/00; C22B 3/22

(52) U.S. Cl. CPC C22B 23/0461; C22B 3/22; C22B 23/043

(57) ABSTRACT

The present invention provides a method for processing a metal-containing feed comprising at least one Ni compound and/or at least one Co compound, said feed further comprising one or more impurities, said method comprising the steps of: i. reacting in an aqueous medium at a pH between 1.5 and 10 said metal-containing feed with a sulphidising agent, thereby obtaining a slurry comprising a Ni- and/or Co-containing solid phase and an aqueous phase comprising one or more water-soluble salts of Mn, Mg, Al, Fe, Ca, B, Na and/or U; ii. separating said solid phase and said aqueous phase.

### TECHNICAL FIELD

The present invention relates to a method for processing a lithium-free, metal-containing feed comprising at least one Ni compound and/or at least one Co compound, said feed further comprising impurities.

### INTRODUCTION

Nickel is an important industrial metal which finds primarily applications in stainless steel production, nonferrous corrosion-resistant alloys, electroplating, or alloy steel. High-purity nickel is essential for developing different applications. Nickel having a purity above 98% can be obtained from refining nickel ore resources such as nickel sulphide ore and nickel oxide ore. Often, these ores also comprise an amount of iron. Also, cobalt is an important industrial metal with uses primarily in alloys, battery materials, catalyst materials and pigments.

As the availability of high-purity nickel resources is decreasing, new processes and refineries for purifying nickel containing materials are required. Likewise, sourcing of cobalt is constrained by limited natural occurrence and availability primarily in politically unstable regions. Nickel and cobalt refineries will need to allow for high capacities and high efficiency of the processes to yield elemental nickel and/or cobalt, or a nickel and/or cobalt compound in a desired quantity and high-purity. Amongst other processes, the sulphidation of Ni and/or Co from laterite ore or battery scrap materials is considered one of the more promising routes.

In this respect, Liu S. et al. provide an effective way for a robust recovery of Ni from laterite ore by H₂ reduction using sodium thiosulfate (Na₂S₂O₃) as a promoter. It was found that a Ni content of 9.97% and a Ni recovery of 99.24% were achieved with 20 wt. % Na₂S₂O₃ at 1100° C., Liu S. et al. (2021) A Robust Recovery of Ni From Laterite Ore Promoted by Sodium Thiosulfate Through Hydrogen-Thermal Reduction. Front. Chem. 9:704012. doi: 10.3389/fchem.2021.704012.

CN 113 802 002 discloses a method for recycling valuable metals in a lithium battery through a wet process. According to the method, waste lithium battery powder is selectively leached under the condition that hydrogen sulphide gas is pressurized and introduced, so that Mn, Li and Al metal ions enter a first-stage leaching solution, nickel, cobalt, copper and iron exist in first-stage leaching residues in the form of sulphides, only a small amount of sulfuric acid is consumed in the process, then the pH value of the first-stage leaching solution is adjusted to remove aluminium and manganese. Subsequent to the first-stage leaching process, the method requires an elaborate purification procedure to obtain high-purity Ni.

Yet, novel processes are required to afford the nickel and/or cobalt in high purity and in high efficiency in use of energy and materials.

### SUMMARY

The current invention provides in a solution for at least one of the above mentioned problems by providing a method for processing a lithium-free, metal-containing feed according to claim 1. The inventors contemplated that compounds such as nickel hydroxide and cobalt hydroxide form a water-soluble nickel sulphate and a water-soluble cobalt sulphate, respectively, upon contact with sulphuric acid in absence of a sulphidising agent. Formation of such water-soluble compounds impedes a straightforward recovery and results in a reduced recovery of Ni and Co from the process. Hence, it was found that sulphidation preferably takes place first at a relatively higher pH, such as between 3 and 10, to allow for the full conversion, more specifically of the full sulphidation of Ni and/or Co compounds in the lithium-free, metal-containing feed, and that subsequently an acid is added to further dissolve all impurities with the formation of water-soluble sulphate salts, concomitantly reducing the pH of the aqueous reaction medium to a pH below 3.5 or even below 3.0.

### DETAILED DESCRIPTION OF THE INVENTION

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention. As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise,” “comprising,” and “comprises” and “comprised of” as used herein are synonymous with “include”, “including”, “includes” or “contain”, “containing”, “contains” and are inclusive or open-ended terms that specifies the presence of what follows, e.g., component and do not exclude or preclude the presence of additional, non-recited components, features, element, members, steps, known in the art or disclosed therein.

The recitation of numerical ranges by endpoints includes all numbers and fractions subsumed within that range, as well as the recited endpoints. All percentages are to be understood as percentage by weight, abbreviated as “wt. %” or as volume percent, abbreviated as “vol. %”, unless otherwise defined or unless a different meaning is obvious to the person skilled in the art from its use and in the context wherein it is used. Unless otherwise indicated, wt. % of an element or compound is calculated relative to the dry weight of the compound or composition comprising said element or compound.

In the context of the present invention, the term “MHP” is to be considered as an abbreviation of the term “mixed hydroxide precipitate.” Mixed hydroxide precipitate (MHP) is an intermediate product of nickel metallurgy derived from processing laterite ores which contains primarily nickel and a minor amount of cobalt. MHP is a solid product which is typically prepared by extracting nickel and cobalt from laterite ores.

In the context of the present invention, the term “CHIP” is to be considered as an abbreviation of the term “cobalt hydroxide intermediate precipitate.” Cobalt hydroxide intermediate is comprised primarily of cobalt, and typically has a cobalt content of 25 wt. % to 40 wt. %, relative to the total weight of said intermediate product. Typically, said CHIP comprises a significant amount of nickel. CHIP's are known to have a very low amount of impurities, which render them attractive for processes according to the present invention.

In the context of the present invention, the term “lithium-free, metal-containing feed” is synonymous to the term “metal-containing feed” and refers to a solid feed comprising an MHP product, a CHIP product, or a mixture of two or more MHP products, two or more CHIP products, or a mixture of one or more MHP products and one or more CHIP products. Preferably, said metal-containing feed comprises at least one Ni compound and/or at least one Co compound. Preferably, said Ni compound and said Co compound are comprised as a Ni (II) compound and as a Co (II) compound, respectively. Yet, said Ni compound and said Co compound may also be comprised in higher oxidation states such as 3+ or 4+, or said metal-containing feed may comprise a mixture of Ni and/or Co compounds in oxidation state 2+ and in oxidation state 3+ and/or 4+.

In the context of the present invention, the term “lithium-free, metal-containing feed” refers to a solid feed containing less than 3 wt. % lithium, relative to the total weight of said feed, preferably less than 2 wt. % lithium, preferably less than 1 wt. % lithium, and more preferably less than 0.5 wt. % lithium. Most preferably, said feed comprises no lithium.

In the context of the present invention, the term “continuous process” is to be considered as a process in which the produced solution has a substantially constant composition. Specifically, a continuous process is a process in which the produced solution has a constant composition within the range of what are considered normal process variations. More specifically, the produced solution has a composition whereby the concentration of each ingredient is within the range of +/−20% or less, preferably +/−10% or less, more preferably +/−5% or less, even more preferably +/−3% or less of its average concentration. In a preferred embodiment, the present invention provides a continuous process which operates under steady-state conditions.

In the context of the present invention, the term “aqueous medium” is used for a water-based solution. The aqueous medium facilitates the handling of the contents of the reactor, such as mixing or pumping. The aqueous medium may already contain some of the other ingredients taking part in the reaction, or those can be added later. Said aqueous medium may in particular contain the mineral acid.

Preferably, a mineral acid, such as sulphuric acid or hydrochloric acid, is intermittently or gradually fed to the process according to the present invention. Said lithium-free, metal-containing feed may be fed intermittently or gradually to the process. Yet, said lithium-free, metal-containing feed is preferably fed in the initial phase of the process only. The mineral acid may be added as such, or may be produced in situ, e.g., by adding NiSO₄ or NiCl₂ to the aqueous reaction medium in which H₂S is introduced as sulphidising agent. Upon contact of NiSO₄ or NiCl₂ with H₂S, the sulphidised metals, e.g., NiS and/or CoS, precipitate and the mineral acid, sulphuric acid or hydrochloric acid, respectively, is produced in situ. Advantageously, according to such an embodiment, the total amount of Co and/or Ni in the aqueous medium is increased which allows for improved recovery efficiency. The process is sufficiently robust to cope with Co and/or Ni containing solutions from impure waste streams.

The sulphidising agent used in the contacting step should obviously be susceptible to react with Co and/or Ni compounds. Suitable sulphidising agents should therefore preferably be at least partially soluble in the aqueous medium. Preferably, a sulphidising agent, such as H₂S or NaHS, is fed to the process according to the present invention at a substantially constant concentration and flow rate. Preferably, the feed rate of said sulphidising agent to the process is controlled within the range of +/−20% or less, preferably +/−10% or less, more preferably +/−5% or less, even more preferably +/−3% or less of its feed rate.

In a first aspect, the present invention provides a method for processing a lithium-free, metal-containing feed comprising at least one Ni compound and/or at least one Co compound, said feed further comprising one or more impurities comprising Mn, Mg, Al, Fe, Ca, B, Na and/or U, said method comprising the steps of:
i. contacting said lithium-free, metal-containing feed with a sulphidising agent in an aqueous medium at a pH between 1.5 and 10, thereby obtaining a slurry comprising a Ni- and/or Co-containing solid phase and an aqueous phase comprising one or more water-soluble salts of Mn, Mg, Al, Fe, Ca, B, Na and/or U; and
ii. separating said solid phase and said aqueous phase, thereby obtaining a solid phase comprising Ni (II) sulphide and/or Co (II) sulphide and an aqueous phase comprising one or more water-soluble components, such as salts, of Mn, Mg, Al, Fe, Ca, B, Na and/or U.

Preferably, step i. comprises the steps of:
a. contacting said metal-containing feed with a sulphidising agent in presence of a mineral acid in an aqueous medium at a pH between 3 and 10, thereby obtaining a slurry;
b. adding a mineral acid to the slurry obtained in step a. to obtain a slurry having a pH lower than 3; and
c. adding a sulphidising agent to the slurry obtained in step b., thereby obtaining a slurry comprising a Ni- and/or Co-containing solid phase and an aqueous phase comprising one or more water-soluble salts of Mn, Mg, Al, Fe, Ca, B, Na and/or U.

Preferably, said lithium-free, metal-containing feed comprising at least one Ni compound and/or at least one Co compound is provided as a solid or as a slurry, i.e. a solid in aqueous medium. The pH of said aqueous medium in step i. is preferably controlled by adding a mineral acid such as sulphuric acid or hydrochloric acid. A basic pH in the range of 7 to 10 may be the result of the basicity of the lithium-free, metal containing feed. Specifically, the present invention provides a process whereby said lithium-free, metal-containing feed in said aqueous medium is first reacted with said sulphidising agent at a pH between 3.0 and 10, preferably between 3 and 7, more preferably between 3 and 6, and whereby the pH of said aqueous medium is subsequently lowered to a pH below 3.0. More preferably, said pH of said aqueous medium is lowered to a pH from 1.5 up to 3.0. Lowering said pH further to a pH value below 1.5 is equally possible. Thus, step i. essentially takes place in at least two stages, whereby each stage of step i. is performed at a different pH. Preferably, the sulphidation reaction of step i. is performed in a closed-type reactor to avoid the emanation of hazardous gases. Preferably, the reactor off-gas is recycled to the feed of the reactor.

The inventors contemplated that compounds such as nickel hydroxide and cobalt hydroxide form a water-soluble nickel sulphate and/or a water-soluble cobalt sulphate, respectively, upon contact with sulphuric acid in absence of a sulphidising agent. Formation of such water-soluble compounds results in a reduced recovery of said Ni and Co. Hence, it was found that sulphidation preferably takes place first at a higher pH, such as a pH between 3 and 10, to allow for the full conversion, more specifically of the full sulphidation, of Ni and/or Co compounds in the lithium-free, metal-containing feed, and that subsequently a mineral acid such as sulphuric acid is further added to dissolve all impurities with the formation of water-soluble sulphate salts, concomitantly reducing the pH of the aqueous reaction medium to a pH below 3.0 or even below 2.5. Preferably, said sulphidation takes place in a first stage at a pH between 3 and 6, preferably between 3 and 5, more preferably between 3 and 4. Preferably, said sulphidation takes place in a second stage, after lowering the pH of the aqueous solution, at a pH between 1.5 and 3.0, preferably between 2 and 3, more preferably at a pH of about 2.2, 2.4, 2.6, 2.8 or any value there in between. Preferably, the difference of pH between said first stage and said second stage is at least 0.2 pH units, preferably at least 0.5 pH units, more preferably at least 1 pH unit, or even at least 1.5 pH units.

Accordingly, it is anticipated to provide a process which allows to selectively leach impurities such as Mg and Mn from a feed material comprising Ni and/or Co. Other impurities typically included in such lithium-free, metal-containing feed include, but are not limited to, Al, Fe, Ca, B, Na and U. Impurities are typically included in an amount of less than 10 wt. %, relative to the total weight of the metal-containing feed, preferably less than 5 wt. %, or even less than 2 wt. %. Other impurities such as, but not limited to, Zn and Cu do not form water-soluble salts under the circumstances of the process and therefore tend to remain in the solid phase. Such impurities may be separated from said Ni and/or said Co in refining processes according to the state of the art. Furthermore, organic carbon present in the metal feed may be washed out as a water-soluble compound, and will be collected in the aqueous phase.

Generally, refining process flowsheets for Ni and/or Co MHP and/or CHIP refining rely on the extraction of impurities such as Mn and Mg from solution. The current process offers an alternative way to remove Mg and Mn from Ni. The following set of reactions ensures that Ni and Co, if present, are collected in the solid phase while selected impurities in the lithium-free, metal-containing feed, such as Mn and Mg, are collected in the aqueous phase:

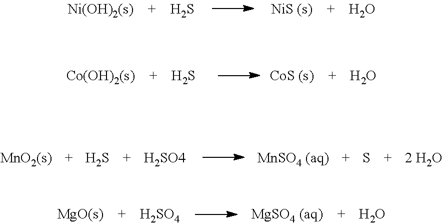

Other elements that are also removed through the formation of a water-soluble salt are Al, Fe, U, Na, B, Ca and U. Numerous further impurities that may be present in the feed material, such as F, W, Si, P, C, K, Fe, Cl, SO₄, and will be collected in the aqueous phase. Other impurities such as Cu, Zn, Pb, and Cd will report to the solid residue. The production of the solid residue comprising the Co and/or Ni sulphides depleted in Mn has several advantages for the hydrometallurgical refining process. It allows for more efficient processes as Mn does not dilute the Ni- and/or Co-bearing solution and the need to isolate Mn, e.g., by solvent extraction is avoided.

In a preferred embodiment, the present invention provides a method according to the first aspect of the invention, whereby said solid phase comprising Ni (II) sulphide and/or Co (II) sulphide obtained in step ii. is leached with an acid and/or an oxidizing agent such as Cl₂. As such, a highly pure Ni salt and/or Co salt solution can be obtained while the sulphidising agent can be regenerated and can be recycled to step i. of the inventive process. Leaching of NiS and CoS with an acid leads to the formation of a Ni salt and/or a Co salt, respectively, and to the formation of H₂S. For example, the reaction of NiS with sulphuric acid leads to the formation of NiSO₄ and H₂S, which can advantageously be recycled and re-used as a sulphidizing agent in step i. Likewise, the reaction of NiS with chlorine gas leads to the formation of NiCl₂ and S. S can advantageously be reduced to provide a sulphidizing agent such as H₂S which can be recycled and re-used as a sulphidizing agent in step i.

In a preferred embodiment, the present invention provides a method according to the first aspect of the invention, whereby said lithium-free, metal-containing feed in said aqueous medium is first reacted with said sulphidising agent at a pH between 3 and 8, preferably between 3 and 6. It was found that sulphidation is favoured at higher pH, while a lower pH favours the leaching of impurities from the metal-containing feed. Yet, sulphidation at a too low pH is not sufficiently selective. The inventors have found that optimal process conditions were obtained when a first sulphidation reaction was performed at a pH of about 3 to 4. Preferably, the first sulphidation step is performed for a processing time of 1 to 16 hours, preferably 2 to 12 hours, more preferably 2 to 8 hours.

In a preferred embodiment, the present invention provides a method according to the first aspect of the invention, whereby after reacting said lithium-free, metal containing feed at a pH between 3 and 10, the pH of said aqueous medium is lowered to a pH higher than 1.5 and lower than 3.0. It was found that lowering the pH favours the formation of sulphate salts of impurity metals in the feed. It was also found that lowering the pH below 1.5 does not significantly further improve dissolution of impurities, and it does not sufficiently recompense the cost of mineral acid consumption in the process. The inventors found that optimal process conditions were obtained when the second sulphidation reaction was performed at a pH of about 2.0 to 2.5. Preferably, the second sulphidation step is performed for a processing time of 2 to 16 hours, preferably 2 to 12 hours, more preferably 2 to 8 hours.

A multi-step process is advantageous where most of the process is performed at a pH between 3.0 and 10.0, or even between 3.0 and 6.0, while in the second or any subsequent addition step the pH is lowered to a pH higher than 1.5 and lower than 3.0. Sulphide formation kinetics are favoured at higher pH. For that reason, it is advantageous to perform most of the process at relatively high pH since sulphide formation is the rate limiting step. The lower pH in the second or any subsequent addition step is selected to maximize the dissolution of Mn, and other impurities. After every such addition step, optionally, a solid-liquid separation can be performed. Most of the conversion to sulphides is usually performed in the first reaction step and then completed with the second or any subsequent addition step. Since sulphide formation will not occur at a pH below 1, the process must be completed at a pH between 1 and 5. Working at a pH above the upper limit would result in an insufficient dissolution of Mn.

After completion of the process, the pH may be further lowered to below 1.5 in order to maximize impurity removal. Indeed, while the formed metal sulphides will not redissolve in absence of an oxidizing agent, some impurities can be eliminated from the residue.

The solid residue containing the major part of the Co and/or Ni as Co and/or Ni sulphides, obtained in the step of separating the solids from the solution, can be further treated in different ways. Hydrometallurgical treatment of the solid residue is a preferred option.

A further embodiment describes therefore a process, in which the solid residue is used as starting material in a subsequent hydrometallurgical refining process. The hydrometallurgical refining process comprises the steps of:
leaching the solid residue comprising the Co and/or Ni sulphides with a mineral acid, preferably H₂SO₄ or HCl, optionally in presence of an oxidizing agent such as HCl in presence of oxygen, thereby obtaining a Ni- and/or Co-bearing solution;
under the provision that insoluble solids remain, separating the solution from said solids; and,
crystallizing Ni and/or Co from the Ni- and/or Co-bearing solution, preferably as Ni and/or Co sulphate.

In a preferred embodiment, the mother liquor from the crystallizing unit comprising NiSO₄ and/or CoSO₄, is recycled to the aqueous reaction medium to form sulphuric acid in situ in presence of a sulphidising agent.

In a preferred embodiment, the present invention provides a method according to the first aspect of the invention, whereby the volumetric ratio φ_{AC} of mineral acid used in step i. a., and the total amount of mineral acid used in step i. is between 0.01 and 0.95. Preferably, said ratio φ_{AC} is between 0.05 and 0.90, and more preferably between 0.40 and 0.90. Most preferably, said ratio φ_{AC} is about 0.40, 0.50, 0.60, 0.70, 0.80 or 0.90, or any value there in between.

In a preferred embodiment, the present invention provides a method according to the first aspect of the invention, whereby said lithium-free, metal-containing feed is reacted with said sulphidising agent at a temperature between 20° C. and 80° C., preferably between 30° C. and 80° C. Preferably, said feed is reacted with said sulphidation agent at a substantially constant temperature. Since the reaction is moderately exothermic, only heating may be required in the initial stage of the process. In a preferred embodiment, the temperature is controlled to a temperature below 80° C., preferably to a temperature of between 40° C. and 80° C., and more preferably at a temperature of about 60° C. Ensuring that the reaction temperature is not too high allows for enhanced solubility of H₂S in the aqueous medium, and consequently favours sulphidation reaction kinetics.

In a preferred embodiment, the present invention provides a method according to the first aspect of the invention, whereby said lithium-free, metal-containing feed is reacted with said sulphidising agent at atmospheric pressure, i.e., at 1 bar, or at an underpressure of less than 0.3 bar, preferably less than 0.2 bar, and more preferably less than 0.1 bar. Working at underpressure conditions ensures that H₂S used in the process does not leak to the environment. Preferably, said process proceeds under an atmosphere devoid of oxygen or air. Performing the process, including the filtration step, in absence of oxidizing agents such as oxygen and air avoids the unwanted oxidation of nickel- and/or cobalt sulphides.

In a preferred embodiment, the present invention provides a method according to the first aspect of the invention, whereby the weight ratio of lithium-free, metal-containing feed relative to the amount of aqueous medium is at least 0.05, preferably at least 0.10, more preferably at least 0.15, even more preferably at least 0.20 or even 0.25, and most preferably at least 0.30. Preferably, said weight ratio is at most 0.50, preferably at most 0.45, more preferably at most 0.40. It was found that higher weight ratio allow for a better efficiency of the process in terms of energy consumption. However, higher weight ratio were found to lead to reduced efficiency in separation of impurities such as Ca impurities.

In a preferred embodiment, the present invention provides a method according to the first aspect of the invention, whereby said sulphidising agent is one or more selected of the group comprising H₂S, NaHS, NH₄HS, Na₂S, (NH₄)₂S and Li₂S, preferably of the group comprising H₂S, NaHS and Li₂S. H₂S and NaHS are the preferred sources of sulphides. Most preferably, said sulphidising agent comprises H₂S. H₂S can be introduced in the aqueous medium as such or may be generated in situ by adding elemental sulphur under reducing conditions, more specifically in presence of H₂. In the current invention, the sulphidising agents not only act as precipitation agent to form metal sulphides, but advantageously also as reducing agent for higher valent metals in oxidation states such as 3+ or 4+. The amount of added sulphidising agent is preferably sufficient to saturate the slurry in H₂S. The saturation is easily verified by monitoring the absorption rate of H₂S by the reacting mixture. Saturation provides for optimal kinetics. Alternatively or additionally, NaHS may be introduced as a sulphidising agent. It is assumed that NaHS forms H₂S in the acidic aqueous medium, which dissolves and reacts with the slurry, and NaOH, which reacts with acid to form salt. This salt, although generated in limited quantities, is less desired. Na₂S may likewise be used as sulphidising agent. However, it generates twice as much salt as NaHS, and is therefore less desired. Ammonium sulphide can also be used.

Suitable sulphidising agents should preferably be at least partially soluble in the aqueous medium. For example, Li₂S reacts with the slurry to form a soluble Li salt and a soluble sulphide. On the other hand, sulphides which are insoluble under the described conditions, for example CuS, are not considered a suitable source of sulphides, respectively a sulphidising agent according to the invention.

The mineral acid is preferably chosen from the list consisting of H₂SO₄, HCl, H₃PO₄, and HNO₃, or mixtures thereof. In a preferred embodiment, the present invention provides a method according to the first aspect of the invention, whereby said mineral acid is sulphuric acid. Alternatively, said mineral acid may be hydrochloric acid.

In a preferred embodiment, the present invention provides a method according to the first aspect of the invention, whereby said lithium-free, metal-containing feed comprises Ni and/or Co in an amount of a 5 to 75 wt. %, relative to the total weight of said lithium-free, metal-containing feed, preferably in an amount of 10 to 65 wt. %. Preferably, said lithium-free, metal-containing feed comprises Ni and/or Co in an amount of a 20 to 60 wt. %, more preferably in an amount of 30 to 50 wt. %.

In an alternative embodiment, the present invention provides a method according to the first aspect of the invention, whereby said lithium-free, metal-containing feed comprises battery materials which are devoid of lithium, such as non-lithiated production waste materials obtained from battery production, or partially recycled battery materials which have been stripped from its lithium content.

In a preferred embodiment, the present invention provides a method according to the first aspect of the invention, whereby said lithium-free, metal-containing feed comprises Ni in an amount of a 10 to 70 wt. %, relative to the total weight of said lithium-free, metal-containing feed, preferably in an amount of 20 to 60 wt. %, and more preferably in an amount of 30 to 55 wt. %. Preferably, said lithium-free, metal-containing feed further comprises Co in an amount of a 0.5 to 15 wt. %, relative to the total weight of said lithium-free, metal-containing feed, preferably in an amount of 1 to 10 wt. %, more preferably in an amount of 1 to 5 wt. %.

In a preferred embodiment, the present invention provides a method according to the first aspect of the invention, whereby said Ni compound and/or said Co compound present in said lithium-free, metal-containing feed are in oxidation state 2+. Yet, the inventive method also allows for said Ni compound and said Co compound to also comprise compounds in higher oxidation states such as 3+ or 4+. Preferably, said compounds are water-insoluble compounds. Advantageously, it was found that under the reaction conditions of the present invention, Ni and/or Co metal compounds having a higher oxidation state are efficiently reduced by the sulphidising agent, preferably H₂S, during the first step of the inventive process.

In a preferred embodiment, the present invention provides a method according to the first aspect of the invention, whereby said Ni compound and/or at least one Co compound in said lithium-free, metal-containing feed comprise a carbonate, a hydroxycarbonate, a sulphate, a sulphite, a phosphate, a hydroxide, and/or an oxide. Preferably, said Ni compound and/or at least one Co compound in said lithium-free, metal-containing feed are comprised of a hydroxycarbonate, a hydroxide and/or an oxide, most preferably of a hydroxycarbonate and/or a hydroxide.

In a preferred embodiment, the present invention provides a method according to the first aspect of the invention, whereby said lithium-free, metal-containing feed comprises Mn in an amount of a 1 to 15 wt. %, relative to the total weight of said lithium-free, metal-containing feed, more specifically in an amount of 3 to 10 wt. %.

In a preferred embodiment, the present invention provides a method according to the first aspect of the invention, whereby said lithium-free, metal-containing feed comprises Mg in an amount of a 0.1 to 10 wt. %, relative to the total weight of said lithium-free, metal-containing feed, more specifically in an amount of 1 to 7 wt. %.

In a preferred embodiment, the present invention provides a method according to the first aspect of the invention, whereby said lithium-free, metal-containing feed comprises Al in an amount of a 0.01 to 2.00 wt. %, relative to the total weight of said lithium-free, metal-containing feed, more specifically in an amount of 0.02 to 1.50 wt. %.

In a preferred embodiment, the present invention provides a method according to the first aspect of the invention, whereby said lithium-free, metal-containing feed further comprises Cu in an amount of 0.01 to 0.20 wt. %, relative to the total weight of said lithium-free, metal-containing feed, and/or Zn in an amount of 0.2 to 1.0 wt. %, relative to the total weight of said lithium-free, metal-containing feed.

In a preferred embodiment, the present invention provides a method according to the first aspect of the invention, whereby said lithium-free, metal-containing feed is a powder, said powder preferably having a D50 of less than 100 μm, as determined according to ASTM B822-97 Standard Test Method for Particle Size Distribution of Metal Powders and Related Compounds by Light Scattering, American Society for Testing and Materials, West Conshohocken, PA (1997). ASTM B822-97 is an ASTM standard test method for size determination of particulate metals and compounds by laser diffraction. Preferably, said powder has a D50 of less than 50 μm, more preferably less than 30 μm, and more than 0.1 μm, more preferably more than 1 μm. The metal compounds are better accessible for reactions, and thus more reactive, when present in form of a powder. An average particle size of less than 100 μm, less than 50 μm, or even less than 30 μm is therefore preferred in an industrial setup. It is not required that such a powder is a dry powder, it could as well originate from a wet process, for example a filter cake. This is particularly advantageous as it has been found that the formation of Ni and Co sulphide is the rate-determining step.

In a further embodiment, the method according to the first aspect of the invention is performed in a continuous operation. In such a setup, the feed and acid are added continuously to the reactor while the slurry is extracted from the reactor. The addition and extraction can also be performed batchwise, e.g., repeatedly, every 30 minutes. Continuous operation has several advantages. Firstly, continuous operation intensifies the use of reactor equipment. Secondly, the quality of the solid Co and/or Ni sulphides is more consistent since they are formed in a steady state regime. This facilitates further refining. In an alternative embodiment, the method according to the first aspect of the invention is performed in a batch operation. In such an operation, the first stage of the sulphidation process at a pH between 3.0 and 6.0 is performed in a first reactor, and the second stage of the process at a pH below 3.0 is performed in a second, separate reactor.

### EXAMPLE

The following example is intended to further clarify the present invention, and is nowhere intended to limit the scope of the present invention.

### Example 1

220 kg of impure Ni hydroxide powder is added to a reactor. 800 L of water is added and the mixture is agitated. The lithium-free, metal-containing feed product comprises 32 wt. % Ni, 5.5 wt. % Mn, 1.6 wt. % Co, 0.8 wt. % Al and 2.4 wt. % Mg.

H₂S is injected in the slurry at a constant rate of 20 kg/h. The temperature is adjusted to 40° C. A H₂SO₄ solution (1000 g/L) is added at a constant rate of 3.8 kg/h to achieve in a first stage a pH at 3.7, and in a second stage a pH of about 2.8. The temperature is maintained at 40° C. and H₂S is continuously injected at the specified rate. Addition of H₂SO₄ was stopped when the pH of the slurry is 2.5, this was the case after 13 hours.

The slurry is filtered to yield 110 kg solid residue after washing and drying, and 700 L solution. The mass balance of the complete experiment can be found in Table 1 below.

TABLE 1
Metal feed and recovery (in kg) in solid
residue and solution at pH 2.8.

| | feed | solid phase | aqueous phase |
|---|---|---|---|
| Ni | 70.4 | 69.4 | 1 |
| Mn | 12.1 | 0.20 | 11.90 |
| Co | 3.5 | 3.40 | 0.1 |
| Mg | 5.3 | 0.1 | 5.20 |
| Al | 1.8 | 0.20 | 1.60 |

### Example 2

200 kg of impure Ni hydroxide powder is added to a reactor. 630 L of water is added and the mixture is agitated. The lithium-free, metal-containing feed product comprises 32 wt. % Ni, 5.5 wt. % Mn, 1.6 wt. % Co, 0.8 wt. % Al and 2.4 wt. % Mg.

H₂S is injected in the slurry at a constant rate of 20 kg/h. The temperature is adjusted to 60° C. 38 kg of H₂SO₄ is added during 6 hours to achieve a pH of the slurry of 6.3 at the end of step 1. In step 2, 9 kg of acid (1000 g/L H₂SO₄) is added to the slurry during 6 hours to achieve a pH of 1.96. The H₂S injection rate is maintained at 20 kg/h in step 2. The temperature is maintained at 60° C.

The slurry is filtered to yield 122 kg solid residue after washing and drying, and 550 L solution. The mass balance of the complete experiment can be found in Table 2 below.

TABLE 2
Metal feed and recovery (in kg) in solid
residue and solution at pH 1.96.

| | feed | solid phase | aqueous phase |
|---|---|---|---|
| Ni | 64 | 63.1 | 0.9 |
| Mn | 11 | 1.2 | 9.8 |
| Co | 3.2 | 3.2 | 0.0 |
| Mg | 4.8 | 0.1 | 4.7 |
| Ca | 0.9 | 0.4 | 0.5 |
| Al | 1.8 | 0.1 | 1.7 |
| Fe | 0.3 | 0.1 | 0.2 |
| U | 0.00500 | 0.0002 | 0.0048 |

### Example 3

300 kg of Li-depleted battery scrap is added to a reactor. 1300 L of water is added and the mixture is agitated. The metal-containing feed product comprises 33 wt. % Ni, 8 wt. % Mn, 7.4 wt. % Co, 1.9 wt. % Li, 0.5 wt. % Al, 0.3 wt. % Cu 0.9 wt. % F, 0.1 wt. % Fe and 33 wt. % C.

H₂S is injected in the slurry at a constant rate of 40 kg/h. The temperature is adjusted to 40° C. 88 kg of H₂SO₄ is added during 2 hours to achieve a pH of the slurry of 4.3 at the end of step 1. In step 2, 35 kg of acid (1000 g/L H₂SO₄) is added to the slurry during 3.5 hours to achieve a pH of 2.4. The H₂S injection rate is maintained at 20 kg/h in step 2. The temperature is maintained at 40° C.

The slurry is filtered to yield 272 kg solid residue after washing and drying, and 1200 L solution. The mass balance of the complete experiment can be found in Table 3.

TABLE 3
Metal feed and recovery (in kg) in solid residue and solution.

| | feed | solid phase | aqueous phase |
|---|---|---|---|
| Ni | 98 | 97.2 | 0.8 |
| Mn | 24 | 2.0 | 22.0 |
| Co | 22 | 20.9 | 1.1 |
| Li | 5.8 | 0.2 | 5.6 |
| Al | 1.4 | 0.2 | 1.2 |
| Cu | 1 | 1 | 0.0 |
| F | 2.6 | 0.1 | 2.5 |
| Na | 0.3 | 0 | 0.3 |
| W | 0.02 | 0 | 0.02 |
| B | 0.00500 | 0.0001 | 0.0049 |

### Example 4

Two reactors in series are used to perform a continuous two-step sulphidation process, referred to as reactor A and reactor B. The lithium-free, metal-containing feed product comprises 32 wt. % Ni, 5.5 wt. % Mn, 1.6 wt. % Co, 0.8 wt. % Al and 2.4 wt. % Mg.

200 kg/hr of the feed product and 760 L/hr of water are continuously added to reactor A and the mixture is agitated. After reacting slurry is pumped from reactor A to reactor B in order to maintain a level of 4 m³ in reactor A. The slurry is continuously removed from reactor B onto a filter in order to maintain a level of 4 m³. H₂S is continuously injected in reactor A and B with a mass flow of 80 kg/hr and 40 kg/hr, respectively. After 7 days operation, the pH in reactor A mounts to 4.6. HCl is added to the reactor B in order to control the pH at 2, mounting to a mass flow of 82 kg/hr HCl solution (430 g/L).

After 7 days, the slurry is filtered to yield 102 kg solid residue per hour after washing and drying, and 750 L solution. The mass balance of the complete experiment can be found in Table 4.

TABLE 4
Metal feed and recovery (in kg) in solid residue and solution.

| | feed | solid phase | aqueous phase |
|---|---|---|---|
| Ni | 64 | 63.8 | 0.2 |
| Mn | 11 | 0.2 | 10.8 |
| Co | 3.2 | 3.2 | 0.0 |
| Mg | 4.8 | 0.1 | 4.7 |

### Example 5

122 kg of sulphide residue produced in example 2 are added to an autoclave together with 150 L of sulfuric acid (1000 g/L H₂SO₄) and 1050 L water. The sulphide residue comprises 52 wt. % Ni, 2.6 wt. % co and 35 wt. % S, further comprising 13.4 wt. % impurities. The slurry is heated to 60° C. and an oxygen pressure of 5 bara is put on the reactor. During 6 hours the temperature is maintained at 60° C. and the oxygen is added in order to maintain 5 bara.

After 6 hours, the slurry is filtered to yield 36 kg solid residue after washing and drying, and 1120 L solution. The mass balance of the complete experiment can be found in Table 5. It is found that about 80% of S present in the sulfide residue is oxidized to elemental S.

TABLE 5
Metal feed and recovery (in kg) in solid residue and solution.

| | feed | solid phase | aqueous phase |
|---|---|---|---|
| Ni | 63.0 | 1.6 | 61.4 |
| Co | 3.2 | 0.2 | 3.0 |
| S | 42.7 | 34.2 | NA |

1-17. (canceled)

18. A method for processing a solid metal-containing feed comprising at least one Ni compound and/or at least one Co compound, and Li in an amount of less than 3 wt. %, relative to the total weight of said feed, said feed further comprising one or more impurities comprising Mn, Mg, Al, Fe, Ca, B, Na and/or U, said method comprising the steps of:
i. a. contacting said solid metal-containing feed with a sulphidising agent in the presence of a mineral acid in an aqueous medium at a pH between 3 and 10, thereby obtaining a slurry;
b. adding a mineral acid to the slurry obtained in step a. to obtain a slurry having a pH lower than 3;
c. adding a sulphidising agent to the slurry obtained in step b., thereby obtaining a slurry comprising a Ni- and/or Co-containing solid phase and an aqueous phase comprising one or more water-soluble salts of Mn, Mg, Al, Fe, Ca, B, Na and/or U; and
ii. separating said solid phase and said aqueous phase, thereby obtaining a solid phase comprising Ni (II) sulphide and/or Co (II) sulphide and an aqueous phase comprising one or more water-soluble salts of Mn, Mg, Al, Fe, Ca, B, Na and/or U.

19. The method according to claim 18, wherein step i. comprises contacting said solid metal-containing feed with a sulphidising agent in an aqueous medium prior to introducing a mineral acid.

20. The method according to claim 18, wherein said solid phase obtained in step ii. is leached with an acid and/or an oxidizing agent to regenerate said sulphidising agent, and whereby the regenerated sulphidising agent is used in step i.

21. The method according to claim 18, wherein said solid metal containing feed is reacted at a pH between 3.0 and 6.0, prior to lowering the pH of said aqueous medium to a pH between 2.0 and 2.5.

22. The method according to claim 18, wherein the volumetric ratio PAC of mineral acid used in step i. a., and the total amount of mineral acid used in step i. is between 0.40 and 0.90.

23. The method according to claim 18, wherein said solid metal-containing feed in said aqueous medium is reacted with said sulphidising agent in step i. a. at a pH between 3.0 and 4.0.

24. The method according to claim 18, wherein said solid metal-containing feed is reacted with said sulphidising agent at a temperature between 25° C. and 80° C.

25. The method according to claim 18, wherein said solid metal-containing feed is reacted with said sulphidising agent at atmospheric pressure.

26. The method according to claim 18, wherein said sulphidising agent is one or more selected of the group consisting of H₂S, NaHS, NH₄HS, Na₂S, (NH₄)₂S and Li₂S.

27. The method according to claim 18, wherein said mineral acid is sulphuric acid.

28. The method according to claim 18, wherein said solid metal-containing feed comprises Ni and/or Co in an amount of 5 to 75 wt. %, relative to the total weight of said solid metal-containing feed.

29. The method according to claim 18, wherein said Ni compound and/or at least one Co compound in said solid metal-containing feed comprises a carbonate, a hydroxycarbonate, a sulphate, a phosphate, a hydroxide, and/or an oxide.

30. The method according to claim 18, wherein said solid metal-containing feed comprises Mn in an amount of 1 to 15 wt. %, relative to the total weight of said solid metal-containing feed.

31. The method according to claim 18, wherein said solid metal-containing feed comprises Mg in an amount of 0.1 to 10 wt. %, relative to the total weight of said solid metal-containing feed.

32. The method according to claim 18, wherein said solid metal-containing feed comprises Al in an amount of 0.01 to 2.00 wt. %, relative to the total weight of said solid metal-containing feed.

33. The method according to claim 18, wherein said solid metal-containing feed further comprises Cu in an amount of 0.01 to 0.20 wt. %, relative to the total weight of said solid metal-containing feed, and/or Zn in an amount of 0.2 to 1.0 wt. %, relative to the total weight of said solid metal-containing feed.

34. The method according to claim 18, wherein said solid metal-containing feed is a powder having an average particle size D50 of between 0.1 and 100 μm, as determined according to ASTM B822-97.
